(19) United States
(12) Patent Application Publication
(10) Pub. No.: US 2016/0334868 A1
(43) Pub. Date: Nov. 17, 2016

(54) METHOD AND SYSTEM FOR ADAPTING A DISPLAY BASED ON INPUT FROM AN IRIS CAMERA

(71) Applicant: Dell Products L.P., Round Rock, TX (US)

(72) Inventors: Roman Joel Pacheco, Leander, TX (US); Karunakar P. Reddy, Austin, TX (US); Mitchell Anthony Markow, Hutto, TX (US)

(21) Appl. No.: 14/714,033

(22) Filed: May 15, 2015

(51) Int. Cl. G06F 3/01; G06K 9/00

(52) U.S. Cl. CPC G06F 3/013; G06K 9/00604; G06K 9/0061; G06K 9/00617

(57) ABSTRACT

Systems and methods for adapting a display based on input from an iris camera are disclosed. The method includes receiving an image captured by an iris camera, processing the image to determine a status of an eye of a user of a display, determining whether the user eye comfort is adequate based on the status of the eye of the user, and in response to determining that the user eye comfort is not adequate, adjusting a setting of the display.

### TECHNICAL FIELD

The present disclosure relates in general to information handling systems, and more particularly to a method and system for adapting a display based on input from an iris camera.

### BACKGROUND

As the value and use of information continues to increase, individuals and businesses seek additional ways to process and store information. One option available to users may be information handling systems. An information handling system generally processes, compiles, stores, and/or communicates information or data for business, personal, or other purposes thereby allowing users to take advantage of the value of the information. Because technology and information handling needs and requirements vary between different users or applications, information handling systems may also vary regarding what information may be handled, how the information may be handled, how much information may be processed, stored, or communicated, and how quickly and efficiently the information may be processed, stored, or communicated. The variations in information handling systems allow for information handling systems to be general or configured for a specific user or specific use such as financial transaction processing, airline reservations, enterprise data storage, or global communications.

Information handling systems may include a variety of hardware and/or software components that may be configured to process, store, and/or communicate information. Information handling systems may include a display which may be used to present and communicate information. When using an information handling system, a user may experience symptoms associated with eye strain due to lowered blinking frequency, squinting, or other factors which may be referred to as computer vision syndrome (CVS). CVS may cause user discomfort such as headache or dry eyes.

### SUMMARY

In accordance with the teachings of the present disclosure, disadvantages and problems associated with user discomfort due to computer vision syndrome may be substantially reduced or eliminated.

In accordance with one embodiment of the present disclosure, a method is described for adapting a display that includes receiving an image captured by an iris camera, processing the image to determine a status of an eye of a user of a display, determining whether the user eye comfort is adequate based on the status of the eye of the user, and in response to determining that the user eye comfort is not adequate, adjusting a setting of the display.

In accordance with another embodiment of the present disclosure, an information handling system includes a processor, a memory communicatively coupled to the processor, an iris camera communicatively coupled to the processor and memory, and an eye comfort monitor including instructions in the memory. The instructions are executable by the processor, and, when executed, configure the eye comfort monitor to receive an image captured by the iris camera, process the image to determine a status of an eye of a user of a display, determine whether the user eye comfort is adequate based on the status of the eye of the user, and in response to determining that the user eye comfort is not adequate, adjust a setting of the display.

In accordance with another embodiment of the present disclosure, a non-transitory machine-readable medium including instructions stored therein is disclosed. The instructions are executable by one or more processors, and when read and executed, enable the processor to receive an image captured by an iris camera, process the image to determine a status of an eye of a user of a display, determine whether the user eye comfort is adequate based on the status of the eye of the user, and in response to determining that the user eye comfort is not adequate, adjust a setting of the display.

Other technical advantages will be apparent to those of ordinary skill in the art in view of the following specification, claims, and drawings.

### BRIEF DESCRIPTION OF THE DRAWINGS

A more complete understanding of the present embodiments and advantages thereof may be acquired by referring to the following description taken in conjunction with the accompanying drawings, in which like reference numbers indicate like features, and wherein:

FIG. 1 illustrates a block diagram of an example information handling system, in accordance with certain embodiments of the present disclosure;

FIG. 2 illustrates a block diagram of an example environment in which an information handling system may operate with other local or remote devices, in accordance with certain embodiments of the present disclosure; and

FIG. 3 illustrates a flow chart for an example method for display control based on image data from an iris camera, in accordance with certain embodiments of the present disclosure.

### DETAILED DESCRIPTION

Preferred embodiments and their advantages are best understood by reference to FIGS. 1-3, wherein like numbers are used to indicate like and corresponding parts.

For purposes of this disclosure, an information handling system may include any instrumentality or aggregate of instrumentalities operable to compute, classify, process, transmit, receive, retrieve, originate, switch, store, display, manifest, detect, record, reproduce, handle, or utilize any form of information, intelligence, or data for business, scientific, control, or other purposes. For example, an information handling system may be a personal computer, a network storage resource, or any other suitable device and may vary in size, shape, performance, functionality, and price. The information handling system may include random access memory (RAM), one or more processing resources such as a central processing unit (CPU) or hardware or software control logic, ROM, and/or other types of nonvolatile memory. Additional components of the information handling system may include one or more disk drives, one or more network ports for communicating with external devices as well as various input and output (I/O) devices, such as a keyboard, a mouse, and a video display. The information handling system may also include one or more buses operable to transmit communications between the various hardware components.

For the purposes of this disclosure, computer-readable media may include any instrumentality or aggregation of instrumentalities that may retain data and/or instructions for a period of time. Computer-readable media may include, without limitation, storage media such as a direct access storage device (e.g., a hard disk drive or floppy disk), a sequential access storage device (e.g., a tape disk drive), compact disk, CD-ROM, DVD, random access memory (RAM), read-only memory (ROM), electrically erasable programmable read-only memory (EEPROM), and/or flash memory; as well as communications media such wires, optical fibers, microwaves, radio waves, and other electromagnetic and/or optical carriers; and/or any combination of the foregoing.

FIG. 1 illustrates a block diagram of an example information handling system 100, in accordance with certain embodiments of the present disclosure. Information handling system 100 may generally be operable to receive data from, and/or transmit data to, other information handling systems 100. In one embodiment, information handling system 100 may be a desktop computer, laptop computer, tablet computer, mobile wireless device, wireless communication device, and/or any other suitable computing device. In the same or alternative embodiments, information handling system 100 may be a server or a storage array configured to include multiple storage resources (e.g., hard drives) in order to manage large amounts of data. In some embodiments, information handling system 100 may include, among other suitable components, processor 102, memory 104, mass storage device 106, input-output device 108, graphics system 110, and eye comfort monitor 112.

Processor 102 may include any system, device, or apparatus operable to interpret and/or execute program instructions and/or process data. Processor 102 may include, without limitation, a microprocessor, microcontroller, digital signal processor (DSP), application specific integrated circuit (ASIC), or any other digital or analog circuitry configured to interpret and/or execute program instructions and/or process data. In some embodiments, processor 102 may interpret and/or execute program instructions and/or process data stored in memory 104, mass storage device 106, and/or another component of system 100.

Memory 104 may be communicatively coupled to processor 102 and may include any system, device, or apparatus operable to retain program instructions or data for a period of time (e.g., computer-readable media). Memory 104 may include random access memory (RAM), electrically erasable programmable read-only memory (EEPROM), flash memory, magnetic storage, opto-magnetic storage, or any suitable selection and/or array of volatile or non-volatile memory that retains data after power to system 100 may be removed.

Mass storage device 106 may include one or more storage resources (or aggregations thereof) communicatively coupled to processor 102 and may include any system, device, or apparatus operable to retain program instructions or data for a period of time (e.g., computer-readable media). Mass storage device 106 may retain data after power to system 100 may be removed. Mass storage device 106 may include one or more hard disk drives (HDDs), magnetic tape libraries, optical disk drives, magneto-optical disk drives, compact disk drives, compact disk arrays, disk array controllers, solid state drives (SSDs), and/or any computer-readable medium operable to store data.

Input-output device 108 may be communicatively coupled to processor 102 and may include any instrumentality or aggregation of instrumentalities by which a user may interact with system 100 and its various information handling resources by facilitating input from a user allowing the user to manipulate system 100 and output to a user allowing system 100 to indicate effects of the user's manipulation. For example, input-output device 108 may permit a user to input data and/or instructions into system 100 (e.g., via a keyboard, pointing device, and/or other suitable means), and/or otherwise manipulate system 100 and its associated components. In these and other embodiments, input-output device 108 may include other user interface elements (e.g., a keypad, buttons, and/or switches placed in proximity to a display) allowing a user to provide input to system 100.

Graphics system 110 may be communicatively coupled to processor 102 and may include any system, device, or apparatus operable to receive and process video information. Graphics system 110 may additionally be operable to transmit digital video information to a display. Graphics system 110 may include any internal graphics capabilities including for example, but not limited to, integrated graphics or a graphics card. Graphics system 110 may include graphics drivers, graphics processors, and/or any other suitable components.

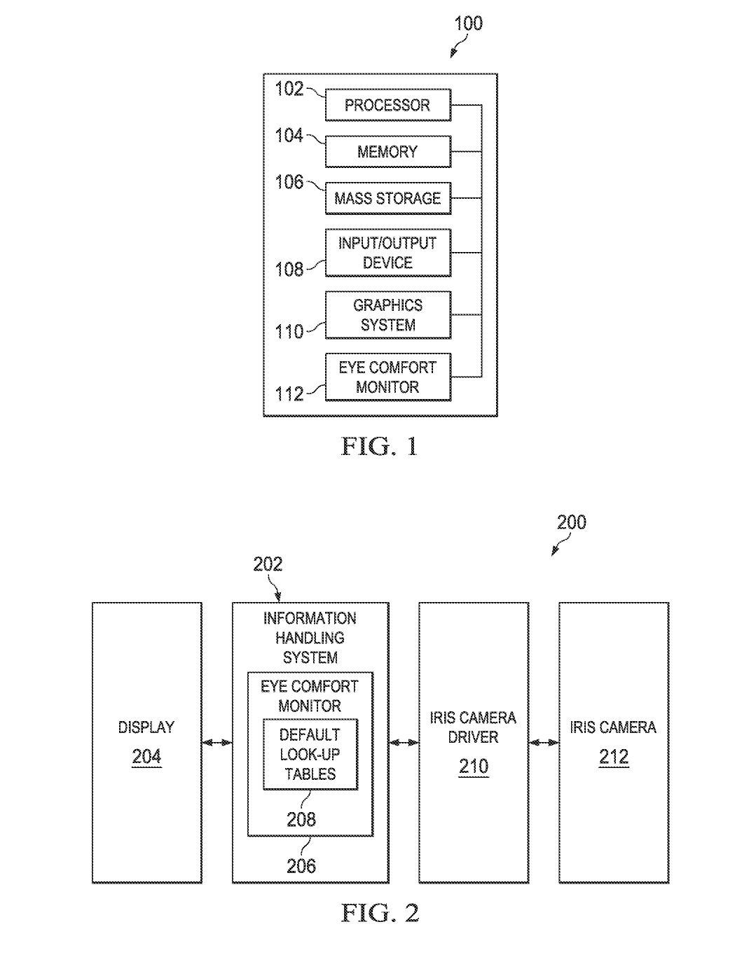

Eye comfort monitor 112 may include logic or instructions for execution by a processor such as processor 102. The logic or instructions of eye comfort monitor 112 may be resident within memory 104 or mass storage device 106 communicatively coupled to processor 104. Eye comfort monitor 112 may be implemented by any suitable software, hardware, firmware, or combination thereof configured as described herein. Eye comfort monitor 112 may be implemented by any suitable set of files, instructions, or other digital information. Eye comfort monitor 112 may include a set of files or other information making up, for example, a virtual machine installation such as an operating system, a virtual deployment environment, or a secured module such as a secured browser. Eye comfort monitor 112 may include such an installation to be installed and configured in the same way among multiple of information handling systems 100. Eye comfort monitor 112 may adjust any suitable setting of a display to enhance the comfort of the user and reduce or prevent symptoms associated with prolonged screen viewing, including the brightness, zoom level, font size, sharpness, refresh rate, color scale, or contrast of a display, as discussed in further detail with reference to FIG. 2.

FIG. 2 illustrates a block diagram of example environment 200 in which an information handling system may operate with other local or remote devices, in accordance with certain embodiments of the present disclosure. Environment 200 may include information handling system 202, display 204, eye comfort monitor 206, default look-up-tables 208, iris camera driver 210, and iris camera 212.

Display 204 may be communicatively coupled to information handling system 202 and appropriate components of information handling system 202 (e.g., a processor such as processor 102 shown in FIG. 1). Display 204 may include any instrumentality or aggregation of instrumentalities to present information to a user. For example, display 204 may be a liquid crystal display (LCD), organic light-emitting diode (OLED) display, plasma display, and/or any other suitable display. Display 204 may include a display suitable for creating graphic images and/or alphanumeric characters recognizable to a user. In certain embodiments, display 204 may be an integral part of a chassis (not explicitly shown) and receive power from power supplies (not explicitly shown) of the chassis, rather than being coupled to the chassis via a cable. In some embodiments, display 204 may comprise a touch screen device capable of receiving user input, wherein a touch sensor may be mechanically coupled or overlaid upon the display and may comprise any system, apparatus, or device suitable for detecting the presence and/or location of a tactile touch, including, for example, a resistive sensor, capacitive sensor, surface acoustic wave sensor, projected capacitance sensor, infrared sensor, strain gauge sensor, optical imaging sensor, dispersive signal technology sensor, and/or acoustic pulse recognition sensor. Display 204 may be a display included in a television, electronic reader, mobile computer, computer monitor, tablet, mobile wireless device, wearable display, or vehicle.

In some embodiments, the user viewing display 204 may experience symptoms associated with eye strain caused by prolonged viewing of display 204. The symptoms may be referred to as Computer Vision Syndrome (CVS) and may include headaches, dry eyes, or squinting. To reduce and/or prevent the symptoms associated with CVS, the settings of display 204 may be adjusted. While the settings of display 204 may be manually adjusted by the user, in some embodiments the user may not perceive the need to adjust display 204. Therefore, the ability to monitor the eye status of a user to determine whether the eye comfort of the user is adequate and adapt the settings of display 204 in response to the detected symptoms may be desired to reduce eye strain and user discomfort.

Iris camera 212 may include any system, device, or apparatus operable to capture images. Iris camera 212 may be operable to capture images having a resolution higher than Video Graphics Array (VGA) and may include an illuminator for near-infrared (IR) illumination. In some embodiments, iris camera 212 may be customized to provide auto focusing, auto zoom, eye tracking, and stabilization capabilities.

Information handling system 202 may communicate with iris camera 212 through iris camera driver 210. Iris camera driver 210 may be any suitable software package operable to control and communicate with iris camera 212. In some embodiments, iris camera driver 210 may be a software application executed by a processor included in information handling system 202, such as processor 102 shown in FIG. 1. Iris camera 212 may receive commands from information handling system 202 via iris camera driver 210. Additionally, iris camera 212 may transmit images to information handling system 202 via iris camera driver 210.

In some embodiments, iris camera 212 may be integrated into information handling system 202 (e.g., a built-in camera). In other embodiments, iris camera 212 may be a separate component and may be communicatively coupled with information handling system 202 via any suitable connection method including Universal Serial Bus (USB), IEEE 1394 Firewire, RS-232 serial, or via a network connection. The network may include, for example, an ad hoc network, a personal area network (PAN), a local area network (LAN), a wide area network (WAN), a metropolitan area network (MAN), or one or more portions of the Internet or a combination of two or more of these network types. One or more portions of the network may be wired or wireless. As an example, the network may include portions of a wireless PAN (WPAN) (such as, for example, a BLUETOOTH WPAN), a WI-FI network, a WI-MAX network, a cellular telephone network (such as, for example, a Global System for Mobile Communications (GSM) network), WiGig (operating in the 60 GHz frequency band) or other suitable wireless network or a combination of two or more of these.

Iris camera 212 may be configured to capture an image of a user. In some embodiments, iris camera 212 may capture multiple frames per second, based on the frame rate of iris camera 212. Iris camera 212 may be further configured to transmit the captured images to eye comfort monitor 206, via iris camera driver 210.

Eye comfort monitor 206 may be communicatively coupled to display 204 and any other component of information handling system 202 such as a processor, a graphics system, and/or iris camera driver 210. Eye comfort monitor 206 may be similar to eye comfort monitor 112, as described with reference to FIG. 1. In some embodiments, eye comfort monitor 206, may perform adjustments that may be reflected in display 204. In some embodiments, eye comfort monitor 206 may be implemented in, for example, any application, process, script, module, executable, executable program, server, executable object, library, function, or other suitable digital entity.

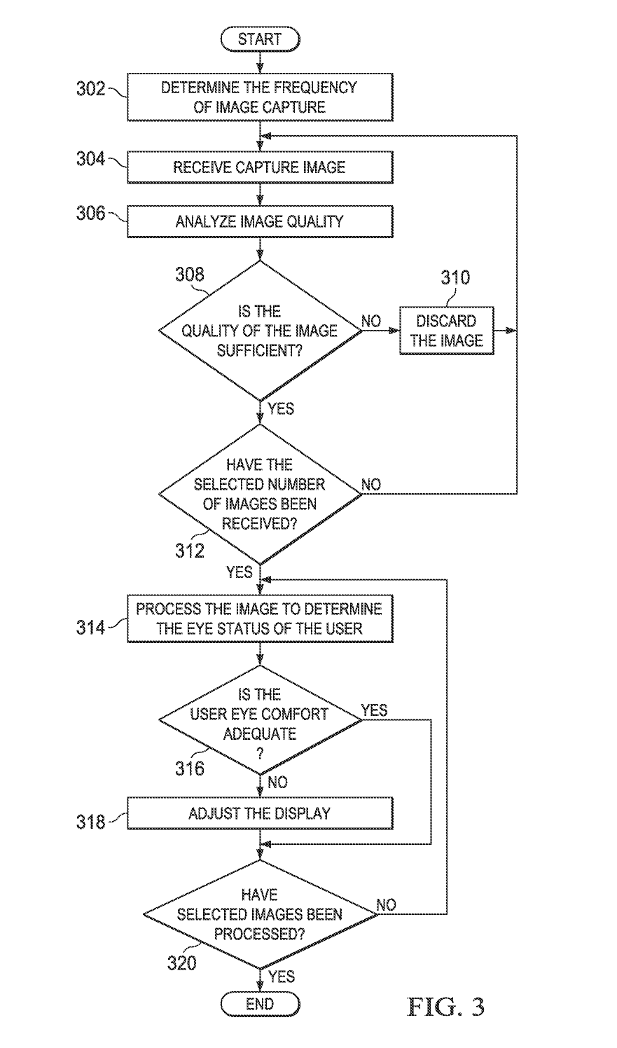

In some embodiments, eye comfort monitor 206 may be configured to adjust the settings of display 204. The adjustments may include adjusting the brightness, font size, zoom level, sharpness, contrast, refresh rate, and/or color scale of display 204. Eye comfort monitor 206 may adjust the settings of display 204 based analysis of one or more images of the eye of a user (e.g., as captured by iris camera 212), a user profile, display default settings, and/or any other suitable criteria. For example, when the image captured by iris camera 212 indicates that the user's pupil is contracted, eye comfort monitor 206 may reduce the brightness level of display 204, as described in further detail with respect to FIG. 3. Eye comfort monitor 206 may use industry standard interfaces to adjust the settings of display 204, such as Windows Display Driver Model (WDDM) or Advanced Configuration and Power Interface (ACPI). The use of industry standard interfaces may allow for any type of display from any manufacturer to be used with the present disclosure. Eye comfort monitor 206 may transmit a settings adjustment to display 204 using standard communication protocols typically used for user initiated changes to display settings.

Eye comfort monitor 206 may determine the frequency at which iris camera 212 captures images of the user. The frequency of image capture may be based on any suitable factor, such as the time of day, the time since the last image capture, the elapsed time of computer usage by the user, or when a new user logs into information handling system 202. As an example of basing the image capture frequency on the time of day, as the lighting conditions change throughout the day, the settings of display 204 may need to change to minimize user discomfort. Therefore, eye comfort monitor 206 may direct iris camera 212 to capture images at predetermined times throughout the day. As an example of basing the image capture frequency on the time since the last image capture, eye comfort monitor 206 may direct iris camera 212 to capture images based on a predetermined time between images. The time between images may be any suitable amount of time, and may be based on a user's privacy settings (e.g., how often the user wishes to an image be captured), optimizing battery life, or safety concerns, as prolonged exposure to IR illumination may cause eye damage. As an example of basing the image capture frequency on the elapsed time of computer usage, eye comfort monitor 206 may direct iris camera 212 to capture images based on the amount of elapsed time of persistent computer usage by the user.

Once iris camera 212 begins capturing images of the user, eye comfort monitor 206 may determine how many frames iris camera 212 is to capture. In some embodiments, iris camera 212 may capture images for a predetermined period of time and the number of frames captured may be based on the frame rate of iris camera 212. In other embodiments, eye comfort monitor 206 may determine the number of frames iris camera 212 is to capture based on real-time analysis of the images as the images are captured. For example, eye comfort monitor 206 may direct iris camera 212 to capture images until a predetermined number of usable frames are captured that provide an adequate sample set for processing. Whether a frame is usable may be based on the picture quality of the image, including whether the image is in focus, whether the user's eyes are open or shut, or whether the user is facing the camera in the image.

After an image is captured, eye comfort monitor 206 may process the image to determine whether the user eye comfort is adequate. The user eye comfort may be inadequate when the user is experiencing one or more symptoms of CVS. Eye comfort monitor 206 may analyze the image of an eye of the user to obtain measurements used to identify and/or prevent any suitable symptom of CVS including whether the pupil is dilated or contracted, whether the user is squinting, whether the user's eyes are darting across the content displayed on display 204, or whether the period between blinks of the user is prolonged. Based on the analysis of the image, eye comfort monitor 206 may generate a control message to send to display 204 to change any suitable setting of display 204 that may mitigate the CVS symptoms experienced by the user, including the brightness, font size, zoom level, sharpness, contrast, refresh rate, or color scale of display 204. In other examples, eye comfort monitor 206 may use the measurements to generate a control message to send to display 204 to change any suitable setting of display 204 to prevent the user from experiencing one or more CVS symptom.

In some embodiments, eye comfort monitor 206 may compare the eye measurements of the user to a threshold and change the settings of display 204 when the user's eye measurements exceed the threshold. The threshold may be based on a profile of the user which may be stored in the memory of information handling system 202 (e.g., memory 104 or mass storage 106 shown in FIG. 1) and accessed by eye comfort monitor 206. The profile of the user may include any suitable information about the user that may be used to determine whether the user is experiencing one or more CVS symptoms including the user's average iris size, blink rate, or eye opening. The measurements included in the user profile may be based on images captured by iris camera 212 and may change over time as the user ages. In some embodiments, the user profile may be tuned based on the user's response to the adjustments made to display 204 by eye comfort monitor 206. For example, eye comfort monitor 206 may determine the responsiveness of the user (e.g., whether the user's pupils return to a size below the threshold after the adjustment, whether the user's blink rate returns to normal, whether the user stops squinting, or whether the user's eyes stop darting across the screen) to changes in the brightness of display 204 and update the user's profile based on the determination. Eye comfort monitor 206 may then use the responsiveness data stored in the user profile to determine the brightness adjustment for display 204 when the user eye comfort is not adequate and/or when the user exhibits symptoms of CVS. In other embodiments, the user profile may be updated based on an action of the user after eye comfort monitor 206 adjusts the settings of display 204. For example, if the user changes the settings of display 204 after eye comfort monitor 206 adjusts the settings as a result of detecting CVS symptoms, eye comfort monitor 206 may adjust the user profile to prevent eye comfort monitor 206 from making a similar adjustment in the future.

Eye comfort monitor 206 may identify the user profile based on the log-in information provided by the user. When the user logs in to information handling system 202, eye comfort monitor 206 may determine if a user profile exists for the user. If a user profile exists, eye comfort monitor 206 may use the profile to determine the adjustments to make to display 204 in the event eye comfort monitor 206 detects that the user eye comfort is not adequate or that the user is experiencing one or more CVS symptoms. If a profile does not exist for the user, eye comfort monitor 206 may reference one or more default look-up tables 208 to identify a default profile for the user. Default look-up tables 208 may include default settings based on the age and/or gender of the user. Eye comfort monitor 206 may use an image from iris camera 212 and facial recognition software to identify the gender and/or approximate age of the user. Based on this information, eye comfort monitor 206 may use default look-up tables 208 to determine the initial settings for the user, such as typical iris size, blink rate, or eye opening for a user of the identified age and/or gender. Eye comfort monitor 206 may create a new profile for the user based on the settings from default look-up tables 208 and tune the profile based on the response of the user. In other embodiments, eye comfort monitor 206 may identify the user profile based on identifying the user based on images from iris camera 212. For example, eye comfort monitor 206 may use an image of the iris of the user to identify a distinguishing characteristic of the user and match the characteristic to the identity of the user.

FIG. 3 illustrates a flow chart for an example method for display control based on image data from an iris camera, in accordance with certain embodiments of the present disclosure. The steps of method 300 may be performed by various computer programs, models or any combination thereof. The programs and models may include instructions stored on a computer-readable medium and operable to perform, when executed, one or more of the steps described below. The computer-readable medium may include any system, apparatus or device configured to store and/or retrieve programs or instructions such as a microprocessor, a memory, a disk controller, a compact disc, flash memory, or any other suitable device. The programs and models may be configured to direct a processor or other suitable unit to retrieve and/or execute the instructions from the computer readable media. For example, method 300 may be executed by processor 102, graphics system 110, eye comfort monitor 112, a user, and/or other suitable source. For illustrative purposes, method 300 may be described with respect to display 204 of FIG. 2; however, method 300 may be used for control of any suitable display.

Although FIG. 3 discloses a particular number of steps to be taken with respect to method 300, method 300 may be executed with greater or lesser steps than those depicted in FIG. 3. In addition, although FIG. 3 discloses a certain order of steps to be taken with respect to method 300, the steps comprising method 300 may be completed in any suitable order.

Method 300 may begin at step 302 where an eye comfort monitor may determine a frequency at which an iris camera is to capture images. The eye comfort monitor may base the frequency of image capture on any suitable factor, including the time of day, the time since the last image capture, the elapsed time of computer usage by a user, or upon a new user logging into an information handling system. In some embodiments, the eye comfort monitor may direct the iris camera to capture an image based on changes in the ambient lighting conditions. In other embodiments, the eye comfort monitor may direct the iris camera to capture an image based on reaching a predetermined time interval between images. In yet a further embodiment the eye comfort monitor may direct the iris camera to capture an image based on the amount of elapsed time of persistent computer usage by a user or direct the iris camera to capture an image when a new user logs in to the information handling system. Based on the frequency at which the iris camera is to capture images, the eye comfort monitor may direct the iris camera to capture an image.

In some embodiments, when the iris camera captures an image, the eye comfort monitor may adjust one or more settings of the iris camera to optimize the images captured by the iris camera. For example, the eye comfort monitor may send a signal to the iris camera, via an iris camera driver, to focus or zoom the iris camera, stabilize the image captured by the iris camera, or direct the iris camera to track an eye of the user.

In step 304, the eye comfort monitor may receive a captured image. The captured image may be transmitted to the eye comfort monitor via an iris camera driver. After receiving the captured image, in step 306 the eye comfort monitor may analyze the image quality of the received image. The analysis may include evaluating any suitable attribute of the image that may impact processing of the image, including determining whether the image is in focus, whether the user's eyes are open or shut, or whether the user is facing the camera in the image.

In step 308, the eye comfort monitor may determine if the quality of the image is sufficient to allow further processing of the image. The eye comfort monitor may base the determination on the analysis performed in step 306. For example, if the user's eyes are shut in the image or if the user is not facing the camera, the image may not allow for further processing due to the inability of the eye comfort monitor to determine the state of the user's eye. If the eye comfort monitor determines that the quality of the image is not acceptable, method 300 may proceed to step 310 to discard the image and then may return to step 304 to receive the next captured image. If the eye comfort monitor determines that the quality of the image is acceptable, method 300 may proceed to step 312.

In step 312, the eye comfort monitor may determine if a selected number of images has been received. The selected number of images may be based on any suitable factor, including the frame rate of the camera or a predetermined number of images that are to be processed to provide accurate analysis results. The predetermined number may be programmed into the eye comfort monitor. For example, the eye comfort monitor may be programmed to process a set number of frames each time the iris camera captures images. Additionally, the iris camera may be programmed to capture images for a predetermined period of time and the number of frames captured may be based on the frame rate of the iris camera. If the eye comfort monitor has received the selected number of images, method 300 may proceed to step 314; otherwise method 300 may return to step 304 to receive the next captured image.

In step 314, the eye comfort monitor may process the images received in step 304 to determine the eye status of the user. The eye comfort monitor may analyze the images of the eye of the user to identify the eye status of the user, including whether the pupil is dilated or contracted, whether the user is squinting, whether the user's eyes are darting across the content displayed on the display, or whether the period between blinks of a user is prolonged. The eye status of the user may indicate that the user is experiencing a symptom of CVS or that the eye comfort of the user is not adequate.

In step 316, the eye comfort monitor may determine whether the user eye comfort is adequate based on the processing performed in step 314. For example, the user eye comfort may not be adequate if the user is experiencing a symptom of CVS and/or if the eye status of the user exceeds a threshold. For example, if the user's pupils are dilated beyond a threshold, the user's comfort may be inadequate. The thresholds may be based on information stored in the user profile. If the user eye comfort is adequate, method 300 may proceed to step 320; otherwise method 300 may proceed to step 318.

In step 318, the eye comfort monitor may adjust the settings of a display based on the discomfort experienced by the user of the display by generating and sending a control message to the display. For example, the eye comfort monitor may adjust the brightness, font size, zoom level, sharpness, contrast, refresh rate, and/or color scale of the display. The eye comfort monitor may determine which setting to adjust based on the particular discomfort that the user is experiencing. For example, if the user's pupil is contracted beyond a threshold, the eye comfort monitor may lower the brightness of the display or if the user's pupil is dilated beyond a threshold, the eye comfort monitor may increase the brightness of the display. As another example, if the user is squinting beyond a threshold level, the eye comfort monitor may increase the font size and/or the zoom level of the display or if the user's eyes are darting across the content presented on the display, the eye comfort monitor may decrease the font size and/or zoom level of the display. As a further example, if the blinking rate of the user has dropped below a threshold, the eye comfort monitor may provide blink stimuli to encourage the user to blink. The blink stimuli may be any suitable stimuli that causes a user to blink, including a pop-up message, patterns in frames that trigger blinking, pixel shifts, display flickering or flashing, or display blurring.

As the attributes of an eye of a user may vary from user to user, the thresholds used by the eye comfort monitor to identify symptoms of CVS may be based on a profile of the user. The profile of the user may include any suitable information and/or measurements particular to the user that may be used in determining whether the user eye comfort is adequate or whether the user is experiencing CVS symptoms including average iris size, average blink rate, or average eye opening. The measurements included in the user profile may be obtained from images captured by the iris camera and may change over time as the user ages and the user's average measurements change. In some embodiments, the user profile may be tuned based on the user's response to adjustments made by the eye comfort monitor to the display. For example, the eye comfort monitor may determine the responsiveness of the eye of the user to changes in the brightness of the display and update the profile based on the determination. The eye comfort monitor may then use the responsiveness data stored in the user profile to determine the amount of brightness adjustment to make to the display when the user exhibits symptoms of CVS. In other embodiments, the user profile may be updated based on an action of the user after the eye comfort monitor adjusts the settings of the display. For example, if the user changes the settings of the display after the eye comfort monitor adjusts the settings as a result of detecting CVS symptoms, the eye comfort monitor may adjust the user profile to cause the eye comfort monitor to make future adjustments similar to the user's adjustment.

In some embodiments, the eye comfort monitor may identify the user and the user profile based on the log-in information provided by the user. In other embodiments, the eye comfort monitor may identify the user through the use of facial recognition and/or an image of the iris of the user captured by the iris camera. If the eye comfort monitor is unable to match the user to a profile, the eye comfort monitor may create a new profile for the user. The initial profile for the user may be based on default look-up tables that may include information about the typical iris size, typical blink rate, and/or typical eye opening for a user of various ages and/or genders. The eye comfort monitor may use facial recognition techniques to identify the approximate age and/or gender of the user and then match the age and/or gender to the eye attribute information included in the default look-up tables. Once the user profile is created and populated with information from the default look-up tables, the eye comfort monitor may tune the user's profile based on the response of the user to the display adjustments made by the eye comfort monitor.

In step 320, the eye comfort monitor may determine if the selected images have been processed. If the selected images have been processed, method 300 may be complete, otherwise method 300 may return to step 314 to process the next selected image.

Modifications, additions, or omissions may be made to method 300 without departing from the scope of the present disclosure. For example, the order of the steps may be performed in a different manner than that described and some steps may be performed at the same time. Additionally, each individual step may include additional steps without departing from the scope of the present disclosure.

Although the present invention and its advantages have been described in detail, it should be understood that various changes, substitutions and alterations can be made herein without departing from the spirit and scope of the invention as defined by the following claims.

What is claimed is:

1. A method for adapting a display comprising:
receiving an image captured by an iris camera;
processing the image to determine a status of an eye of a user of a display;
determining whether the user eye comfort is adequate based on the status of the eye of the user; and
in response to determining that the user eye comfort is not adequate, adjusting a setting of the display.

2. The method of claim 1, further comprising determining a frequency at which the iris camera is to capture images.

3. The method of claim 1, further comprising analyzing a quality of the image.

4. The method of claim 1, wherein determining whether the user eye comfort is adequate includes:
analyzing the image of the user to identify at least one of an age or a gender of the user;
determining a typical eye attribute based on the identification; and
processing the image based on the typical eye attribute.

5. The method of claim 1, wherein the setting of the display is at least one of a brightness, a font size, a zoom level, a sharpness, a refresh rate, a color scale, a blink stimuli, or a contrast of the display.

6. The method of claim 1, wherein the status of an eye of the user is at least one of a pupil contraction, a pupil dilation, an eye squinting, an eye darting, or a decreased blink rate.

7. The method of claim 1, wherein determining whether the user eye comfort is adequate includes comparing the status of the eye of the user to a threshold, wherein the threshold is based on a profile of the user.

8. An information handling system comprising:
a processor;
a memory communicatively coupled to the processor;
an iris camera communicatively coupled to the processor and memory; and
an eye comfort monitor including instructions in the memory, the instructions executable by the processor, the instructions, when executed, configure the eye comfort monitor to:
receive an image captured by the iris camera;
process the image to determine a status of an eye of a user of a display;
determine whether the user eye comfort is adequate based on the status of the eye of the user; and
in response to determining that the user eye comfort is not adequate, adjust a setting of the display.

9. The system of claim 8, the instructions further configure the eye comfort monitor to determine a frequency at which the iris camera is to capture images.

10. The system of claim 8, the instructions further configure the eye comfort monitor to analyze a quality of the image.

11. The system of claim 8, wherein determining whether the user eye comfort is adequate includes:
analyzing the image of the user to identify at least one of an age or a gender of the user;
determining a typical eye attribute based on the identification; and
processing the image based on the typical eye attribute.

12. The system of claim 8, wherein the setting of the display is at least one of a brightness, a font size, a zoom level, a sharpness, a refresh rate, a color scale, a blink stimuli, or a contrast of the display.

13. The system of claim 8, wherein the status of an eye of the user is at least one of a pupil contraction, a pupil dilation, an eye squinting, an eye darting, or a decreased blink rate.

14. The system of claim 8, wherein determining whether the user eye comfort is adequate includes comparing the status of the eye of the user to a threshold, wherein the threshold is based on a profile of the user.

15. A non-transitory machine-readable medium comprising instructions stored therein, the instructions executable by one or more processors, the instructions, when read and executed for causing the processor to:
receive an image captured by an iris camera;
process the image to determine a status of an eye of a user of a display;
determine whether the user eye comfort is adequate based on the status of the eye of the user; and
in response to determining that the user eye comfort is not adequate, adjust a setting of the display.

16. The non-transitory machine-readable medium of claim 15, the instructions further causing the processor to determine a frequency at which the iris camera is to capture images.

17. The non-transitory machine-readable medium of claim 15, the instructions further configure the processor to analyze a quality of the image.

18. The non-transitory machine-readable medium of claim 15, wherein determining whether the user eye comfort is adequate includes:
analyzing the image of the user to identify at least one of an age or a gender of the user;
determining a typical eye attribute based on the identification; and
processing the image based on the typical eye attribute.

19. The non-transitory machine-readable medium of claim 15, wherein the setting of the display is at least one of a brightness, a font size, a zoom level, a sharpness, a refresh rate, a color scale, a blink stimuli, or a contrast of the display.

20. The non-transitory machine-readable medium of claim 15, wherein the status of an eye of the user is at least one of a pupil contraction, a pupil dilation, an eye squinting, an eye darting, or a decreased blink rate.
